(19) United States
(12) Patent Application Publication
(10) Pub. No.: US 2014/0034033 A1
(43) Pub. Date: Feb. 6, 2014

(54) Pancake engine with overexpansion

(71) Applicant: Stanley Edwin Lass, Ogden, IA (US)

(72) Inventor: Stanley Edwin Lass, Ogden, IA (US)

(21) Appl. No.: 13/507,911

(22) Filed: Aug. 6, 2012

(51) Int. Cl. F02B 75/02

(52) U.S. Cl. 123/65 R

(57) ABSTRACT

The crankshaft is stopped part way through the upstroke by a rotary start stop mechanism. As the piston nears the end of the compression stroke, vertical ridges on the piston, in conjunction with mating vertical ridges in the cylinder head, effectively partition the combustion chamber into multiple combustion chambers. In a spark ignition engine, this allows the compression ratio of a smaller cylinder. For HCCI (homogenoous charge compression ignition) operation, the partitions can be ignited at varying times, somewhat averaging the pressure rise. Expansion proceeds to BDC, providing overexpansion. The exhaust valve(s) open prior to BDC. The upstroke continues to the crankshaft stopping angle. Purge is by poppet valves with the inlet valves generating a swirl about the cylinder axis. Power is varied by varying the frequency of cycles, not by reducing the power per cycle.

### BACKGROUND OF THE INVENTION—PRIOR ART

Applicant is not aware of any prior art that uses a swirl purge about the cylinder axis, inlet poppet valve(s) (on the periphery of the cylinder head) to exhaust poppet valve(s). However, Toyota and Ricardo built two stroke engines that used poppet valves in the cylinder head. They may have used tumble purge with the swirl orthogonal to the cylinder axis.

Applicant is not aware of any prior art that partitions the combustion chamber by ridges on the piston which almost mate with ridges on the cylinder head, when the piston is close the cylinder head.

Applicant is not aware of any prior art that varies the crankshaft stopping angle to vary the effective compression ratio. Compression does not start until the crankshaft starts again.

### SUMMARY

The cylinder diameter is typically a few times or more of the the stroke. The cylinder is somewhat pancake in shape, hence the name pancake engine. This invention describes how to operate a single cylinder engine, or cylinders operated in unison.

A “Rotary Start Stop Mechanism with Dogs”, (U.S. application Ser. No. 12/378,761) is typically connected to a flywheel on the input side. The flywheel supplies energy for compression and absorbs energy from combustion. The rotary start stop mechanism always stops at the same angle relative to itself. However, rotating the mechanism about the crankshaft axis also rotates the engine crankshaft stop angle. Varying the stopping point of the crankshaft varies the stopping point of the piston in the cylinder, providing variable compression of the charge in the cylinder. The rotary start stop mechanism stops and starts the engine crankshaft at typically 25-60% of the upstroke.

The engine cycle begins with compression.

As the piston nears the end of the compression stroke, vertical ridges on the piston, in conjunction with almost mating vertical ridges in the cylinder head, effectively partition the combustion chamber into multiple combustion chambers. In a spark ignition engine, this allows the compression ratio of a smaller cylinder. For detonation like combustion of lean mixtures operation, the partitions can be ignited at varying times, somewhat averaging the overall pressure rise.

Expansion proceeds to BDC, providing overexpansion. The exhaust valve (s) in the cylinder head open prior to BDC. After BDC, the upstroke continues to the crankshaft stopping angle.

When the blowdown is ending, the inlet poppet valve(s) in the cylinder head adjacent to the cylinder wall, open with the flow directed tangential to the cylinder wall. This provides a swirling flow about the cylinder axis, crowding the combusted gas out of the exhaust valve(s). The intake and exhaust valves close while gasoline or a gaseous fuel is injected into the swirling flow. The injection only begins once the risk of fuel escaping out the exhaust valve(s) is past. This ends the engine cycle.

Power is varied at low levels by varying the frequency of cycles, not by reducing the power per cycle. One or more cycles is skipped by leaving the crankshaft stopped at the crankshaft stopping angle for one or more flywheel revolutions.

### DRAWINGS—FIGURES

FIG. 1 is an inlet and exhaust poppets cylinder head with a mask on the exhaust valve.

FIG. 2 is an example four inlet and three exhaust poppets cylinder head with masks on the outer exhaust valves, and includes partitions.

FIG. 3 is the cross section of a partition at TDC.

FIG. 4 shows a single cylinder engine with an angularly adjustable rotary start stop mechanism.

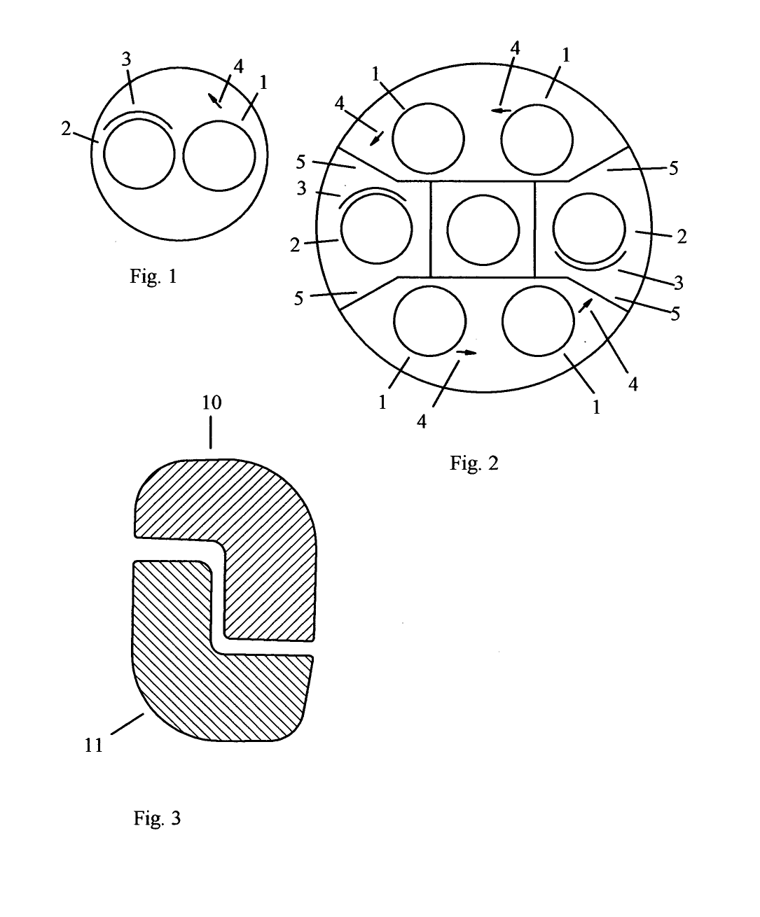

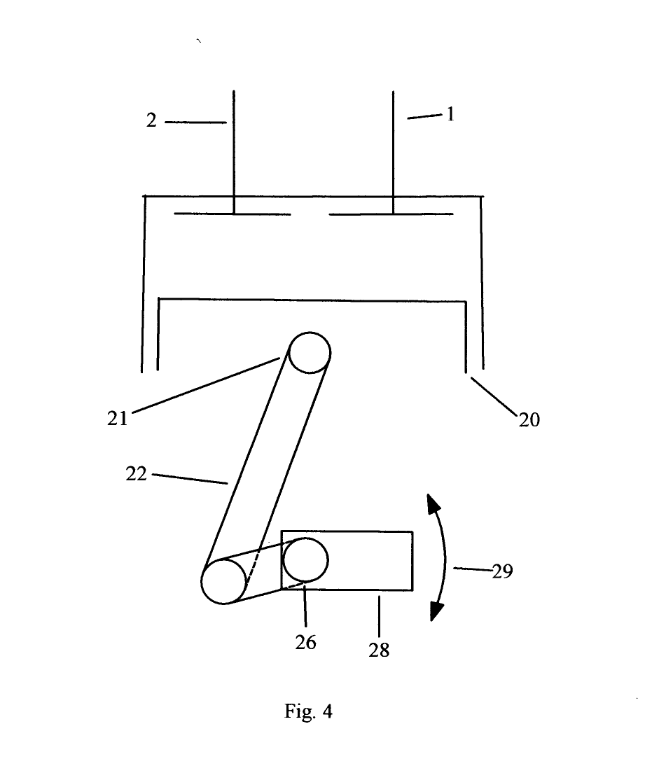

### DRAWINGS—NUMBERS

1 inlet poppet valve

2 exhaust poppet valve

3 mask next to exhaust poppet valve

4 arrow showing flow direction out of an inlet poppet valve

5 partition when piston is near top dead center

10 surface of piston or cylinder for one side of partition

11 surface of piston or cylinder for other side of partition

20 piston

21 wristpin

22 connecting rod

26 crankshaft axis

28 rotary start stop mechanism

29 angular position adjustment of the rotary start stop mechanism

### DETAILED DESCRIPTION

The charge is the fuel air mixture which is ignited in the combustion chamber.

For description purposes, the cylinder axis is assumed to be vertical with the cylinder head at the top.

TDC is top dead center which is the position of the piston at maximum compression, or at the end of the upstroke.

BDC is bottom dead center which is the position of the piston at maximum expansion, or at the end of the downstroke.

RSSM is a rotary start stop mechanism.

SI is spark ignition.

DLM is detonation of a lean mixture.

HCCI is homogenous charge compression ignition.

To provide a context for the description, consider replacing the four pistons of a four cylinder engine with a single large double diameter piston, keeping the stroke the same. This gives the same engine displacement. Also, that a conventional crankshaft—connecting rod assembly moves the piston.

The crankshaft is connected to a RSSM (rotary start stop mechanism) which can stop the crankshaft at a given angle. The stopping angle of the crankshaft can be varied by rotating the RSSM. (The hold jaw is part of the RSSM. It holds the crankshaft at the given stop angle.)

This varies the compression ratio by varying the amount of charge that is compressed into the combustion chamber. Restated, the higher the piston is at the stop angle, the lower the effective compression ratio.

In contrast to a conventional internal combustion engine, power is mostly controlled by limiting the frequency of power cycles. This is accomplished by leaving the crankshaft stopped while the flywheel continues on an integer number of revolutions.

Compression, Combustion and Expansion

Large cylinders in spark ignition engines need a reduced compression ratio to avoid detonation. The reason is that by the time the flame front reaches the end gas, the pressure and temperature is high enough in the end gas to cause detonation. This is due to charge motion caused by the combusted portion of the charge expanding, compressing the end gas, causing it to auto-ignite.

Partitioning the combustion chamber into several combustion chambers, each with an igniter, e.g. a spark plug, limits the distance traveled by the flame front and limits the charge motion which raises the temperature and pressure of the end gas. The effect is that of multiple small combustion chambers, allowing the use of a higher compression ratio, i.e. similar to the compression ratio allowed by a smaller cylinder.

For spark ignition, the partitioning would only need to be in effect for roughly 15-25 degrees before and after TDC. It helps if the spark plug is centrally located within each combustion chamber.

For detonation mode combustion of lean mixtures in a conventional HCCI engine, the charge is diluted enough such that the detonation like combustion is mechanically tolerable. However, the rapid pressure rise is hard on the engine. With combustions in partitioned combustion chambers, staggered in time, the overall pressure rise on the piston can be somewhat evened out and the peak force on the piston is reduced. This may allow a slightly richer mixture to be used.

The partitioning is accomplished with ridges on the piston. Matching ridges on the combustion chamber roof almost contact ridges on the piston in the last several per cent of the piston up stroke. One of the ridges forming a partition has a side at least somewhat parallel to the cylinder axis. The gap between ridges must be large enough such that the accumulated tolerances do not allow clashing of the ridges. The tolerances include side to side and twisting motion of the piston. The resulting gap allows some bleeding between a combusted chamber and one not yet combusted. The gap size varies from the minimum of the accumulated tolerances to the maximum of the accumulated tolerances, and accordingly the rate of bleeding through the gap.

Note that the partitions as shown in the drawings can be mirrored left to right or inverted.

When partitions are used with DLM or HCCI, the cooler cylinder head and piston of the gap will cool the flow through the gap. And further, the opening of the gap will provide some expansion cooling. This will lessen the possibility of ignition in one partition igniting an adjacent partition earlier than desired.

Partition junctions can be handled in a variety of ways, e.g. when three or more partitions join, each partition ends at the bisected angle at the join point. Note that if press some soft clay onto the top of the piston, the resultant image in the clay would show the opposing surface (except for tolerances).

For HCCI (homogenoous charge compression ignition) operation with fuels that have an auto-ignition delay, individual combustion chamber partitions could have a different average clearance at TDC, giving them different effective compression ratios. Prior to ridge mating, the pressure across the cylinder would be uniform. With different effective compression ratios, the auto-ignition timing will vary. The higher compression ratio cylinders would have a higher charge temperature, auto-igniting sooner than the lower compression ratio combustion chambers. Surface temperature within the individual combustion chambers affects the auto-ignition timing. The staggering of combustions in time lessens the peak loading on the piston. As a backup, an external source could cause ignition within a partition.

Blowdown and Purge

The exhaust valve(s) in the cylinder head open prior to BDC. After BDC, the upstroke continues to the crankshaft stopping angle. When the blowdown is ending, the inlet poppet valve(s) in the cylinder head adjacent to the cylinder wall, open with the flow directed tangential to the cylinder wall. This provides a swirling flow about the cylinder axis, crowding the combusted gas out of the exhaust poppet valve(s).

From Heywood “Internal Combustion Engine Fundamentals”, copyright 1988, p.346 FIGS. 8-13 (b) is an example of a swirl generating inlet port. p.347 FIGS. 8-14 has examples of shrouded and masked valves.

Short circuiting is fresh air from an inlet poppet valve escaping out an exhaust valve. A mask on an exhaust valve could lessen the short circuiting by blocking the short circuiting flow path.

The intake and exhaust valves close while gasoline or a gaseous fuel is injected into the swirling flow. The injection only begins once the risk of fuel escaping out the exhaust valve(s) is past. This ends the engine cycle.

Note that for DLM, only need to provide enough fresh air, oxygen really, to combust the fuel was added. (For 30% fuel of a stoichiometric fuel air mix, at least 30% fresh air is needed.) So, the cylinder contents do not need to be largely replaced, only a smaller portion.

Poppet valves that open and close under computer control are available e.g. Sturman and Valeo.

### OPERATION OF INVENTION

Startup and warmup would likely be in spark ignition mode. The stopping angle can be set (by varying the position of the RSSM) to limit the compression ratio to a level sufficient to avoid detonation in spark ignition mode. An even later crankshaft stopping angle, leaving the piston higher in the cylinder, would reduce the power per combustion by both reducing the compression ratio and the amount of charge combusted.

Ambient temperature, atmospheric pressure, fuel characteristics affect the optimum compression ratio. For DLM operation, the temperature and pressure of the charge and the fuel air ratio would be such that auto-ignition at TDC would almost occur on it's own. Some technique to ignite a lean mixture would be used. (Various techniques have been described in the literature to ignite a lean mixture.)

For SI, the stop angle is advanced further past BDC to reduce the effective compression ratio. This reduces the amount of charge compressed into the combustion chamber.

### CONCLUSIONS, RAMIFICATIONS AND SCOPE

It'd seem that there are multiple inventions here. However, the swirl purge about the cylinder axis only works with a large diameter cylinder and a short stroke design. In turn, the large diameter cylinder only works well if the combustion chamber is partitioned in the last several percent of stroke. Also, a compression ratio suitable for HCCI or DLM is high for spark ignition. The variable compression ratio allows reducing it for spark ignition, and even more reduction for supercharged operation.

The RSSM allows using detonation of lean mixtures at low power levels, improving the efficiency at part load operation.

1-5. (canceled)

6. In a 2 stroke internal combustion engine with the piston motion provided by the rotation of a crankshaft with a conventional crankpin to connecting rod to piston mechanism, wherein the improvement comprises:
using a rotary start stop mechanism connected to the crankshaft to substantially stop the piston motion when the piston is in the inward stroke towards the combustion chamber, with at least one open inlet poppet valve oriented to provide a swirl about the cylinder axis, with the displaced combusted gas exiting through the open at least one exhaust valve
whereby purge of combusted gas is accomplished and overexpansion during the full expansion stroke results due to the shortened compression stroke.
